(19) United States
(12) Patent Application Publication
(10) Pub. No.: US 2010/0001538 A1
(43) Pub. Date: Jan. 7, 2010

(54) CASE LOCKING DEVICE

(76) Inventors: Kyoungsu KIM, Anyang-si (KR); Hakryun KANG, Gwangju-si (KR)

Correspondence Address: KED & ASSOCIATES, LLP, P.O. Box 221200, Chantilly, VA, 20153-1200, US

(21) Appl. No.: 12/265,022

(22) Filed: Nov. 5, 2008

(30) Foreign Application Priority Data
Jul. 7, 2008 (KR) 10-2008-0065420

(51) Int. Cl. E05C 1/00

(52) U.S. Cl. 292/137

(57) ABSTRACT

The present invention relates to a case locking device. For example, the outer case and the inner case used for various types of electronic devices such as set-top boxes (STB) are connected by a locking means using a resilient force exerted from an elastic material such as a spring so that the outer case and the inner case may be separated from each other only by using a jig provided separately. Accordingly, the outer case and the inner case may be connected to each other more easily and any general user may be prevented from separating the cases arbitrarily, thus making it possible to effectively prevent catastrophic failures from occurring at the electronic device due to the user's arbitrary manipulation.

This application claims the benefit of Korean Patent Application No. 10-2008-0065420 filed on Jul. 7, 2008, which is hereby incorporated by reference.

### BACKGROUND

1. Field

The present invention relates to a case locking device, and more specifically to a case locking device that enables locking to be more easily done between an outer case and an inner case that are used for various types of electronic devices, for example, such as set-top boxes and the like, and prevents a general user from separating between the two cases arbitrarily.

2. Description of the Related Art

In general, various types of electronic devices, such as set-top boxes receiving digital broadcast, are manufactured and sold in the form of a box that has an outer case and an inner case locked to the outer case. The outer case and the inner case are firmly locked, for example, by screws or other connecting elements such as bolts and nuts.

In the meanwhile, a general user may easily separate the outer case and the inner case from each other by using a flat-head screw driver or Phillips screw driver that may be easily obtained at home when the outer case and the inner case are locked to each other through screws or other connecting elements such as bolts and nuts.

For instance, the general user may arbitrarily release the screws that join the outer case to the inner case by using a flat-head screw driver or Phillips screw driver when an electronic device such as a set-top box does not operate normally.

Accordingly, the number of catastrophic failures gradually increases due to user's arbitrary manipulations. However, there are not yet prepared any solutions of being capable of effectively preventing such failures in advance.

### SUMMARY

The present invention is made in consideration of the above problem, and an aspect of the present invention provides a case locking device that does not only enable locking to be more easily done between an outer case and an inner case that are used, for example, for various types of electronic devices such as set-top boxes and the like, but also prevents a general user from arbitrarily separating the outer case and the inner case from each other by using a common flat-head screw driver or Phillips screw driver.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is a view illustrating a locking unit applying to a case locking device according to an exemplary embodiment of the present invention.

FIG. 2 is a view illustrating an inner case applying to a case locking device according to an exemplary embodiment of the present invention.

FIG. 3 is a view illustrating an outer case applying to a case locking device according to an exemplary embodiment of the present invention.

FIG. 4 is a view illustrating processes where an outer case and an inner case are connected to each other according to an exemplary embodiment of the present invention.

FIG. 5 is a rear view illustrating a state where an outer case and an inner case are connected to each other according to an exemplary embodiment of the present invention.

FIG. 6 is a view illustrating a jig according to an exemplary embodiment of the present invention.

FIG. 7 is a view illustrating processes where a locking unit moves toward the inside of the inner case by protrusions of a jig according to an exemplary embodiment of the present invention.

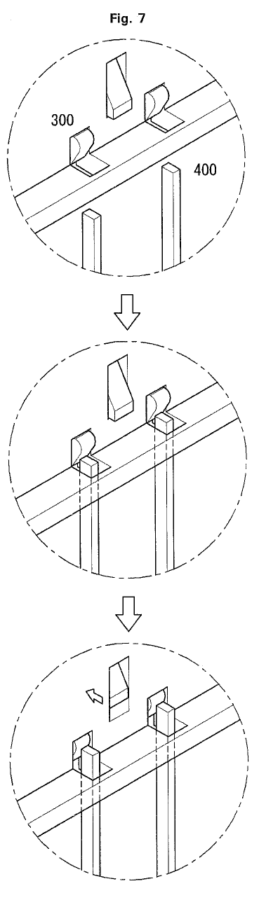

### DETAILED DESCRIPTION OF PREFERRED EMBODIMENTS

Reference will now be made in detail embodiments of the invention examples of which are illustrated in the accompanying drawings.

Hereinafter, a case locking device according to an exemplary embodiment of the present invention will be described in detail with reference to accompanying drawings.

To begin with, the case locking device may apply to various types of electronic devices that are manufactured in the form of a box where an outer case and an inner case are connected to each other. For example, the outer case and the inner case of an electronic device such as a set-top box (“STB”) to which the present invention applies are connected to each other by a connecting means using a resilient force exerted from an elastic material such as a spring.

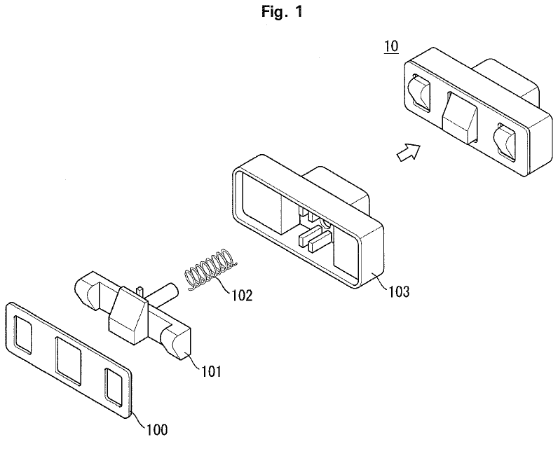

For instance, the locking unit 10 used as a connecting means according to the present invention is configured as an assembly that comprises a cover front 100, a hook 101, a spring 102, and a cover rear 103, as shown in FIG. 1.

In the meanwhile, the hook 101 comprises a protrusion having an inclined angle in the positive direction at its center, and two protrusions having an inclined angle in the negative direction at its both sides.

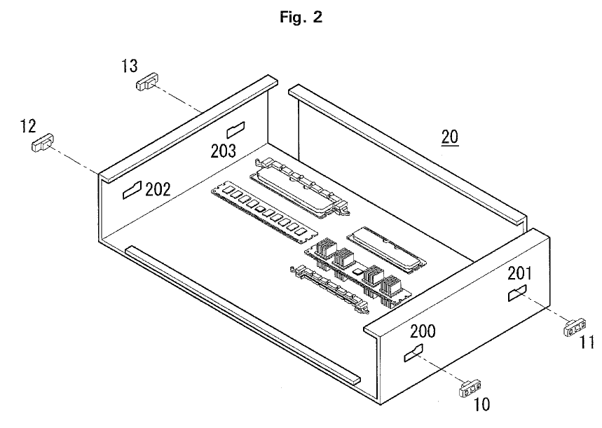

In addition, the locking unit 10 is inserted into an insert hole that is formed at both sides of the inner case. For example, the inner case 20 has four insert holes 200 to 203 at its both sides to insert four locking units 10 to 13 as shown in FIG. 2.

And, each insert hole comprises a through hole with a narrow area and a through hole with a broad area that are integrally formed. Accordingly, the locking unit 10 is firstly inserted through the through hole with the broad area and then transferred in left or right direction toward the through hole with the narrow area. By doing so, the locking unit 10 may be firmly inserted in the through hole with the narrow area.

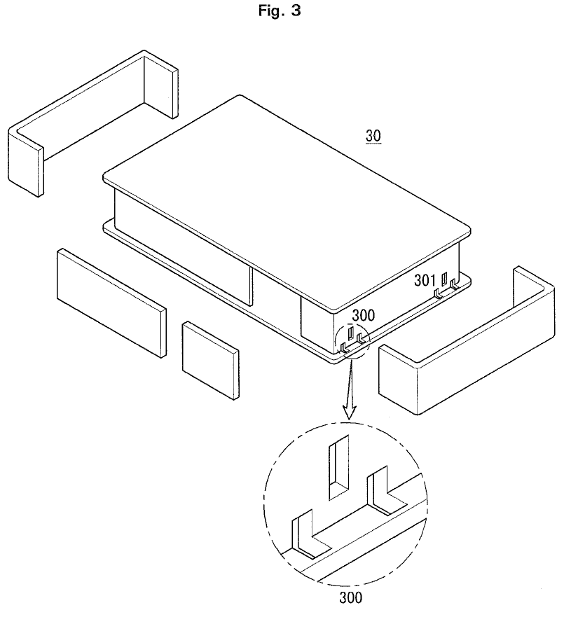

In the meanwhile, four fasteners 300 to 303 are provided at both sides of the outer case 30 to connect to the four locking units 10 to 13 as shown in FIG. 3. Each fastener comprises one hole that penetrates a side surface of the outer case and two holes that penetrate the side surface and the bottom surface of the outer case and has the shape of the letter “L”.

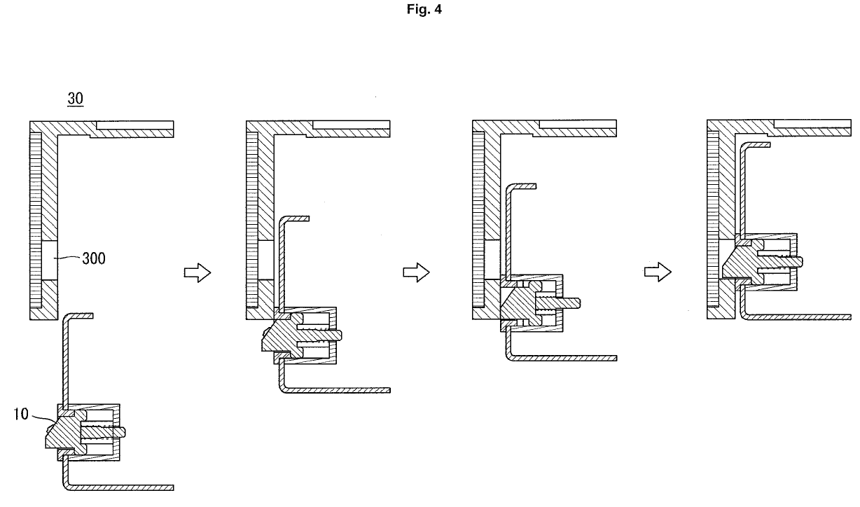

For example, the protrusion formed in the middle of the locking unit 10 gradually moves toward the inside of the inner case when the outer case 30 having the fastener 300 is gradually brought down in the vertical direction, with the locking unit 10 inserted in the insertion hole of the inner case 20, as shown in FIG. 4.

Thereafter, the protrusion of the locking unit returns to the original location by a resilient force exerted from the spring comprised in the locking unit 300, and therefore, the protrusion of the locking unit is inserted into the fastener 300 of the outer case. Consequently, the inner case may be easily connected to the outer case.

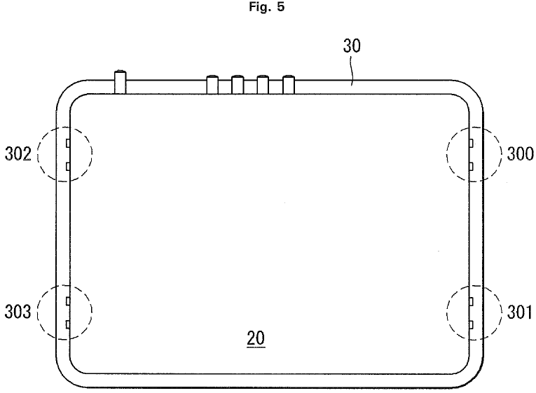

Eight small holes are exposed in four pairs from both sides of the bottom end of the outer case 30, with the outer case and the inner case connected to each other through the above processes, as shown in FIG. 5 which is a rear view of the electronic device.

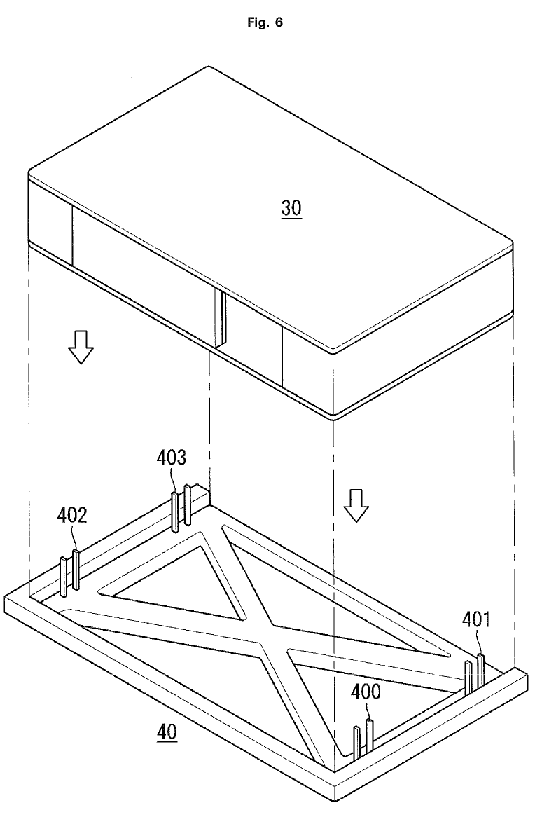

In the meanwhile, a jig 40 is separately prepared, which has eight protrusions provided in four pairs 400 to 403, each of which is inserted into each of the small holes, as shown in FIG. 6. The protrusions are used to separate the outer case and the inner case from each other.

For instance, the electronic device whose outer case is connected to the inner case is properly seated over the jig with the locking units not viewed from the outside, as shown in FIG. 6. When the electronic device is gradually pressed down in the vertical direction in this state, the protrusion 400 formed on the jig is inserted into the fastener 300 formed on the outer case and pushes the locking unit (not shown in FIG. 6) toward the inside of the inner case. Accordingly, the outer case and the inner case locked to each other by the locking unit may be naturally separated.

As a consequence, the general user may not arbitrarily disconnect the outer case and the inner case from each other without the jig, so that catastrophic failures may be effectively prevented from occurring due to user's arbitrary.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A case locking device comprising:
an inner case;
an outer case; and
a locking means that connects or disconnects the inner case and the outer case by a pressing force.

2. The case locking device of claim 1, wherein
an insertion hole is provided at a side surface of the inner case to insert the locking means, and
a fastener is provided at a side surface of the outer case to connect to the locking means inserted in the insertion hole.

3. The case locking device of claim 1, wherein
the locking means comprises an elastic material for connecting the inner case and the outer case to each other.

4. The case locking device of claim 3, wherein
the locking means moves toward the inside of the inner case by a pressing force exerted from the outer case in a vertical or horizontal direction and then locks the outer case and the inner case to each other by a resilient force of the elastic material.

5. The case locking device of claim 1, wherein
the locking means moves toward the inside of the inner case by a pressing force exerted from a protrusion of a jig in a vertical or horizontal direction to separate the outer case and the inner case from each other.

6. The case locking device of claim 5, wherein
the protrusion of the jig is provided near a location corresponding to connection location of the locking means in order to be inserted into a fastener exposed between the outer case and the inner case.

7. The case locking device of claim 1, wherein
the locking means is provided inside the case not to be seen from the outside.

8. The case locking device of claim 1, wherein
the locking means comprises a cover front, a hook, an elastic material, and a cover rear.

9. The case locking device of claim 8, wherein
the hook has a plurality of protrusions having inclined angles formed in different direction.

10. The case locking device of claim 2, wherein
the insert hole comprises a through hole with a narrow area and a through hole with a broad area that are integrally formed to each other.

11. The case locking device of claim 2, wherein
the fastener comprises one hole that penetrates a side surface of the outer case and two holes that penetrate the side surface and the bottom surface of the outer case.
